(19) United States
(12) Patent Application Publication
(10) Pub. No.: US 2010/0252570 A1
(43) Pub. Date: Oct. 7, 2010

(54) BOTTOM LOADING WATER COOLER

(76) Inventor: George M. Yui, Toronto (CA)

Correspondence Address: HPF, P.O. BOX 4442, CHESTERFIELD, MO, 63006-4442, US

(21) Appl. No.: 12/416,781

(22) Filed: Apr. 1, 2009

(51) Int. Cl. B67D 1/00; B67D 5/62; B67D 5/64; B65D 83/00

(52) U.S. Cl. 222/67; 222/146.6; 222/173; 222/400.7; 222/160

(57) ABSTRACT

Bottom loading water coolers are disclosed, which include (1) a cabinet having an exterior portion and an interior portion; (2) a water bottle disposed in the bottom half of the interior portion of the cabinet; (3) a cold tank disposed in the top half of the interior portion of the cabinet and above the water bottle; (4) a bottle tray disposed in the bottom half of the interior portion of the cabinet that is configured to receive the water bottle in an upright position, such that the bottle tray may be reversibly pulled out of, and pushed into, the interior portion of the cabinet; (5) a pump that injects air into the water bottle at defined and periodic intervals; and (6) a specialized probe for transferring water from the water bottle to the cold tank (and for delivering air from a pump to the water bottle).

### FIELD OF THE INVENTION

The present invention relates generally to the field of bottled water coolers and, more particularly, to bottom loading water coolers and remote location water coolers.

### BACKGROUND OF THE INVENTION

The demand for clean and healthy drinking water is increasing dramatically, which is being driven by the rapid growth in population and standards of living across the globe. This demand has translated into a continuing need for safe, clean, and easy to use water dispensers, including for both hot and cold water. Many of the currently-available water dispensers are so-called “top loading” dispensers, which require a person to lift a heavy tank or bottle of water and secure it to the top portion of the dispensing device. This configuration often leads to muscle strain and injury—and, when not loaded properly, may damage the water dispensing device.

As the following will demonstrate, many of the foregoing problems with currently-available water coolers are addressed by the present invention.

### SUMMARY OF THE INVENTION

According to certain aspects of the invention, bottom loading water coolers are provided. The water coolers generally comprise a cabinet having an exterior portion and an interior portion, with the interior portion including a top half and a bottom half. The bottom loading water coolers further include a water bottle that is disposed in the bottom half of the interior portion of the cabinet (in an upright position), with a cold tank disposed in the top half of the cabinet (within the interior portion thereof) and above the water bottle. In certain preferred embodiments, the bottom loading water coolers further include a bottle tray located in the bottom half of the interior portion of the cabinet (close to a floor surface), which is configured to receive the bottom surface of the water bottle (such that the water bottle sits in an upright position on the tray). The invention provides that the bottle tray may be reversibly pulled out of, and pushed into, the interior portion of the cabinet, which enables a user to more easily load and unload a water bottle into the cabinet. Preferably, the bottom loading water coolers further include a pump that injects air into the water bottle, through a probe, at defined and periodic intervals (e.g., injecting air into the water bottle for 4 seconds, followed by a 10 second period of time during which no air is injected into the water bottle). According to certain embodiments, the probe is configured to receive two tubes, with a first tube being adapted to deliver air into the water bottle, and a second tube being adapted to transfer water from the water bottle into a cold tank. The bottom loading water coolers will further include one or more tubes for transferring water from the water bottle, through the probe and to the cold tank, and out of an external tap (which users may open and close to collect water from the water cooler).

According to certain preferred embodiments, the invention provides that the bottom loading water cooler will further comprise a buoyant float. The invention provides that if a volume of water contained within the cold tank exceeds a threshold level, the float will be lifted by the water level and cause a one-way valve that allows water to be dispensed out of, but not into, the cold tank to be closed, such that water will not exit the cold tank through the one-way valve. In addition, the bottom loading water cooler will preferably include a control unit, which causes the pump to stop injecting air into the water bottle when a door attached to the cabinet, which encloses the water bottle, is in an open position. In certain embodiments, the invention provides that the bottom loading water coolers are designed and configured to rest on a floor surface. For example, in certain embodiments, the bottom loading water coolers may exhibit a height of from about 30 inches to about 60 inches.

According to further aspects of the invention, countertop water coolers are provided, which are also referred to as “remote location” water coolers. In general, the countertop water coolers include (1) a cabinet having a cold tank disposed therein, (2) a water bottle located outside of the cabinet (which may rest, for example, on a countertop), which is fluidly connected to the cold tank via a first tube, (3) a pump disposed in the cabinet, which injects air into the water bottle through a second tube at defined and periodic intervals, and (4) a third tube for transferring water from the cold tank and out of an external tap that is affixed to the cabinet. The invention provides that the countertop water coolers are designed to rest on a counter surface. As such, the height of the cabinet for such water coolers will preferably range from about 10 inches to about 30 inches. The invention provides that, similar to the embodiments described above, the pump that is used in connection with the countertop water coolers will inject air into the water bottle at defined and periodic intervals. Similarly, the countertop water coolers will preferably include a buoyant float, which, upon the water level of the cold tank exceeding a certain threshold, will be lifted by the water level and cause a one-way valve that allows water to be dispensed out of, but not into, the cold tank to be closed, such that water will not escape the cold tank through the one-way valve.

The above-mentioned and additional features of the present invention are further illustrated in the Detailed Description contained herein.

### BRIEF DESCRIPTION OF THE FIGURES

FIG. 1: A cross-sectional, front view of an exemplary bottom loading water cooler of the present invention.

FIG. 2: A cross-sectional, side view of an exemplary bottom loading water cooler of the present invention.

FIG. 3: A cross-sectional, side view of an exemplary bottom loading water cooler of the present invention, with the bottle tray in a “pulled out” position, with the cabinet door in an open position.

FIG. 4: A magnified view of portion A of FIG. 2.

FIG. 5: A magnified view of portion B of FIG. 1.

FIG. 6: A side view of the probe described herein and the components thereof.

FIG. 7: A side view of an alternative boot cap, which may be used in connection with the probe of FIG. 6.

FIG. 8: A diagram illustrating the steps that should be followed to remove a probe from an empty water bottle.

FIG. 9: A diagram illustrating the initial steps that should be followed to install the probe into a new, full water bottle.

FIG. 10: A diagram illustrating additional steps that should be followed to install the probe into a new, full water bottle.

### DETAILED DESCRIPTION OF THE INVENTION

The following will describe in detail several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

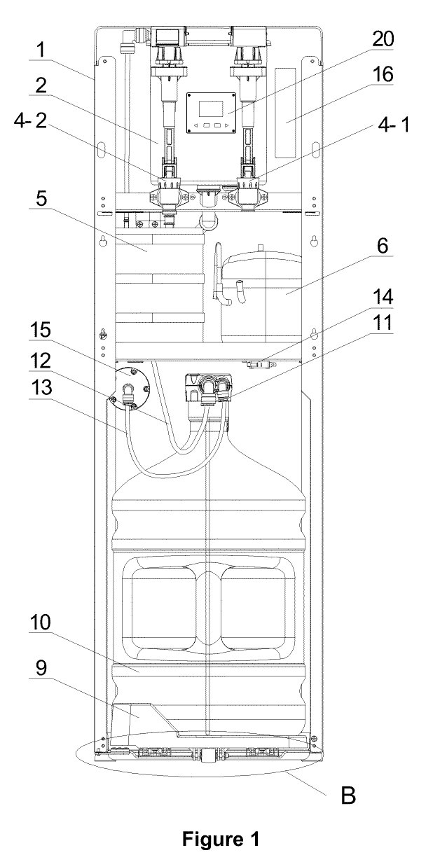

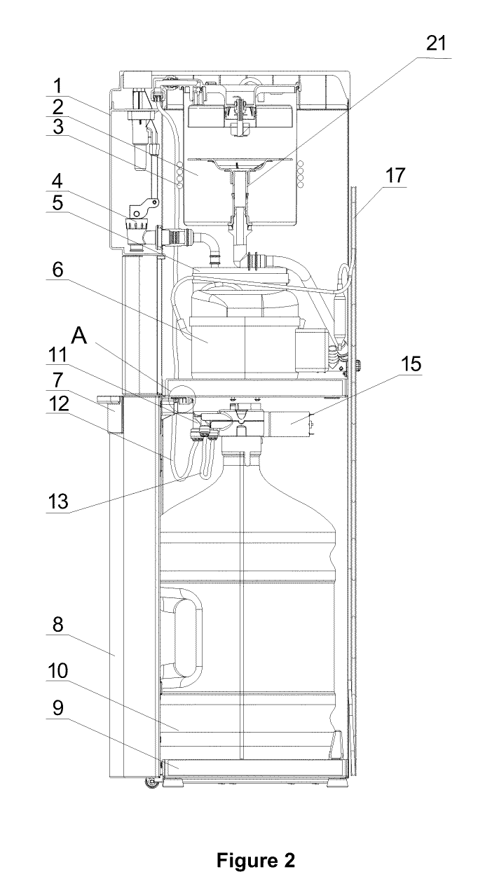

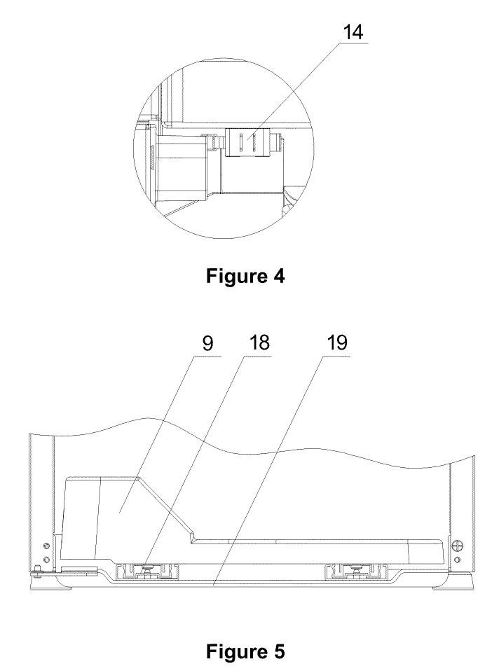

According to certain aspects of the invention, bottom loading water coolers are provided. Referring now to FIGS. 1-5, the water coolers generally comprise a cabinet 1 having an exterior portion and an interior portion, with the interior portion including a top half and a bottom half. The bottom loading water coolers further include a water bottle 10 that is disposed in the bottom half of the interior portion of the cabinet 1 in an upright position, with a cold tank 2 disposed in the top half of the cabinet 1 (within the interior portion thereof) and above the water bottle 10. In addition, the bottom loading water coolers include a hot tank 5, which is connected with the cold tank 2 by a baffle stick and hose 21 (FIG. 2). The cold tank 2 will preferably comprise a means for cooling or chilling the water contained therein, such as by incorporating the use of heat sinks (evaporators) or circulating coolants (refrigerant gasses) along the surfaces thereof. A non-limiting example of such a refrigerant gas includes 134a (tetrafluoroethane). Similarly, the hot tank 5 will preferably include a means for heating the water contained therein, such as by including electric heating coils along or near the surface thereof.

The invention further provides that a winding evaporator 3 is located on the exterior portion of the cold tank 2. The cold tank 2 and hot tank 5 connect with cold 4-1 and hot 4-2 taps separately, on each side of the hot tank 5. Still further, the bottom loading water coolers include a compressor 6, with a first end thereof connected to the evaporator 3, and a second end of the compressor 6 being connected with a condenser 17.

Preferably, the bottom loading water coolers further include a pump 15 that injects air into the sealed water bottle 10 at defined and periodic intervals. For example, the pump 15 may be instructed, by a control unit 16, to inject air into the water bottle 10 for 4 seconds, to cease the injection of air into the bottle 10 for 10 seconds, and then to continuously repeat the foregoing steps. The invention provides that the foregoing method of injecting air into the sealed water bottle 10 represents a preferred means for “priming” the water bottle 10, as explained further below, which causes water to be transferred from the water bottle 10, through the probe 11 described herein, through one or more tubes, and into the cold tank 2. The control unit 16 will, preferably, further comprise a digital display 20 on the front panel thereof, which lists, for example, the local time, hot and cold water temperatures, the beginning and end of heating and cooling periods, and/or other information.

In certain preferred embodiments, the bottom half of the water cooler includes is a door 8, which can be opened or closed by a user. The invention provides that a top portion of the door 8 includes a drip tray 7 (which collects spilled water from the cold 4-1 and hot 4-2 taps). In certain preferred embodiments, the bottom loading water coolers further include a push-and-pull bottle tray 9 located in the bottom half of the interior portion of the cabinet (adjacent to and near a floor surface), which is configured to receive the bottom surface of the water bottle 10 (such that the water bottle 10 sits in an upright position on the tray 9). The invention provides that the bottle tray 9 may be reversibly pulled out of, and pushed into, the interior portion of the cabinet 1, which enables a user to more easily load and unload a water bottle 10 into the cabinet 1. More specifically, and referring to FIG. 5, a water bottle 10 is placed on the bottle tray 9, which rests along a glide 18 that is disposed within a grooved portion of a base plate 19 of the tray 9. The middle portion of the base plate 19 is sunken (or comprises a cut-out portion), so that the water cooler is able to maximize the use of the space above a floor surface, such as about 4 feet above the floor surface, and to reduce the height of the water cooler and to save space.

The water coolers of the present invention further comprise a probe stick assembly 11, which extends the length of the water bottle 10 and ends near or at the bottom surface thereof. The invention provides that a first end of the probe stick assembly 11 is connected with the pump 15, e.g., a revolving piston pump, vis-à-vis an intake tube 13. The invention provides that a second end of the probe stick assembly (probe) 11 is connected with the cold tank 2.

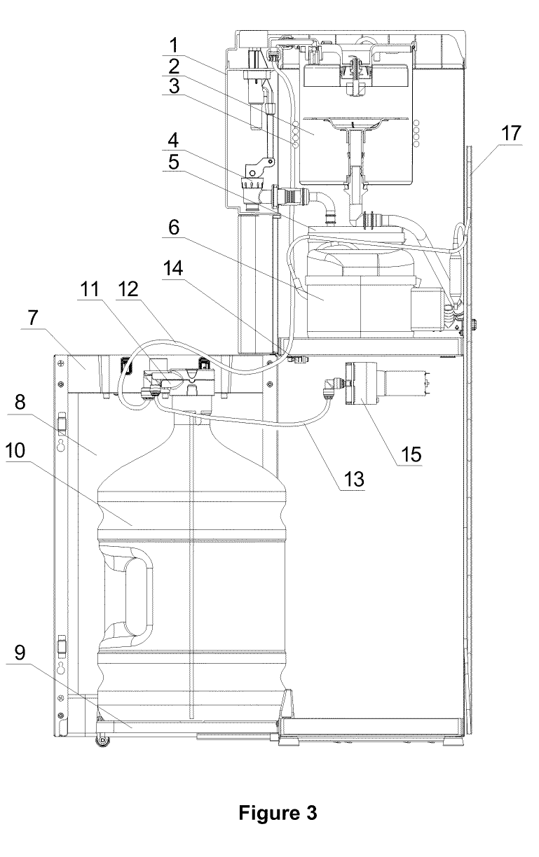

The invention provides that, in operation, the door 8 of the water cooler may be opened, and a user may slide the bottle tray 9 out of the cooler (as shown in FIG. 3). Next, the probe 11 may be lifted out of an old (depleted) water bottle 10, such that the old (depleted) water bottle 10 may be removed from the water cooler. A new (full) water bottle 10 may then be placed on the tray 9, the probe 11 may then be inserted into the bottle 10, and bottle tray 9 and water bottle 10 may then be slid back into the water cooler—and the door 8 may then be closed. In certain preferred embodiments of the present invention, when the door 8 is closed, a door switch transmits a signal to the control unit 16 (with the door switch being capable of sensing the door 8 being closed and sending an electrical signal to the control unit 16). Upon receiving an electrical signal indicating that the door 8 has been closed, the control unit 16 instructs the pump 15 to begin injecting air into the water bottle 10, as described above.

In certain embodiments of the present invention, when the water level in the cold tank 2 is below a set or threshold level, the pump 15 will begin injecting air into the water bottle 10. More specifically, the air is injected into the water bottle 10 through the probe 11 to impart a higher pressure to the air that exists in the top portion of the water bottle 10. This increased air pressure enables the water to flow upwards to the cold tank 2 along the probe 11 and inlet tube 12, so that the water within the cold tank 2 exceeds the minimum threshold level. This facilitates the dispensing of water from, for example, the cold tap 4-1 (when the cold tap 4-1 is moved to an open position).

Still further, the invention provides that when the water level, in the cold tank 2, rises above the baffle 21, the water will flow into the hot tank 5 through a middle baffle hole, which serves to periodically provide the hot tank 5 with a volume of water. According to such embodiments, the tap 4-2 may be opened to cause hot water to be dispensed therefrom. In addition, the invention provides that when the water level, within the cold tank 2, rises to a certain threshold level, a magnetic baffle switch acted upon buoyancy transmits a signal to the control unit 16—which then transmits a signal to the pump 15. This signal will cause the pump 15 to stop injecting air into the water bottle 10 for a defined period of time, such as for 4 minutes.

According to certain alternative, preferred embodiments of the present invention, the water bottle 10 may be constantly “primed,” wherein the pump 15 injects air into the sealed water bottle 10 at defined and periodic intervals. For example, by way of illustration, the control unit 16 may instruct the pump 15 to (a) inject air into the water bottle 10 for about 4 seconds, (b) refrain from injecting air into the water bottle 10 for 10 seconds, and (c) continuously repeats steps (a) and (b). The invention provides that the foregoing methods of “priming” the sealed water bottle 10 is particularly beneficial for the bottom loading water coolers described herein, insofar as it serves to maintain a desirably steady amount of water in the cold tank 2, and a desirably constant amount of air pressure in the water bottle 10, such as between 30 and 60 psi or, preferably, between 40 and 50 psi, such as about 46 psi.

Still further, according to certain preferred embodiments of the invention, the bottom loading water coolers will further comprise a buoyant float, which is located within the cold tank 2 of the water cooler. The invention provides that when a volume of water contained within the cold tank 2 exceeds a threshold level, the float will be lifted (through a buoyancy force) and cause a one-way valve that allows water to be dispensed out of, but not into, the cold tank 2 to be closed, such that water will not exit the cold tank 2 through the one-way valve.

The benefits of the foregoing bottom loading water coolers include, for example, the provision of an ergonomically improved method of loading and unloading water bottles into a water dispenser—which will avoid user injury and damage to the dispenser. The sliding loading tray described herein, in addition to being a bottom loading water cooler, provides such ergonomic advantages. In addition, since the water contained within the water bottle is pumped directly into the cold tank through the probe, as described herein, potential contact between the water and exterior air is substantially minimized, which serves to avoid unwanted water pollution (which enhances water sanitation).

According to certain related aspects of the invention, countertop water coolers are also provided, which are also generally referred to as “remote location” water coolers. In general, the countertop water coolers include (1) a cabinet having a cold tank disposed therein, (2) a water bottle located outside of the cabinet, which is fluidly connected to the cold tank via a first tube, (3) a pump disposed in the cabinet, which injects air into the water bottle through a second tube at defined and periodic intervals, and (4) a third tube for transferring water from the cold tank and out of an external tap that is affixed to the cabinet. The invention provides that the countertop water coolers are designed to rest on a counter surface. As such, the height of the cabinet for such water coolers will preferably range from about 10 inches to about 30 inches. The invention provides that, similar to the embodiments described above, the pump that is used in connection with the countertop water coolers will inject air into the water bottle at defined and periodic intervals, such as the 4 second air injection and 10 second rest period described above. Similarly, the countertop water coolers will preferably include a buoyant float (as described above), which, upon the water level of the cold tank exceeding a certain threshold, will be lifted by the water level and cause a one-way valve that allows water to be dispensed out of, but not into, the cold tank to be closed, such that water will not escape the cold tank through the one-way valve.

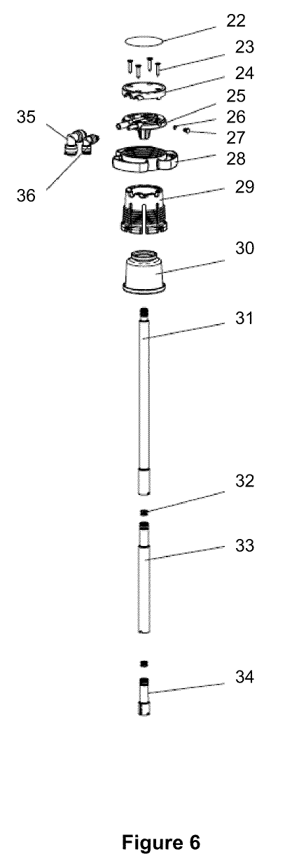

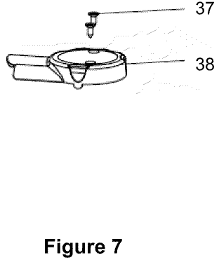

Referring now to FIGS. 6-10, the invention provides that the probe 11 described herein may exhibit a specific and preferred configuration. More particularly, referring to FIG. 6, the invention provides that the probe 11 may comprise a top cap portion (which may comprise a label of desired dimension and content) 22. The top cap portion 22 may secured to a boot cap 24 through one or more screws 23. The probe 11 further comprises a probe housing 25, which will comprise two ports, with a first port being adapted to receive a tube that will inject air into a water bottle 10 and a second port being adapted to receive a tube that will extract water from the water bottle 10 (to be eventually dispensed to a user). FIG. 7 illustrates an alternative design of a probe housing 38, which may have a top cap secured thereto vis-à-vis one or more screws 37. Referring back to FIG. 6, the probe housing 25 will further include a port on the bottom surface thereof, which is adapted to receive a top portion of the upper probe 31. The port on the bottom surface of the probe housing 25 and the top portion of the upper probe 31 may be connected to each other through corresponding threaded portions (i.e., such that the parts may be screwed and connected to each other), by mechanical attachment, or by frictional attachment.

According to certain embodiments, the probe housing 25 will further include a small seal ring 26 and resistive head 27. The invention further provides that the probe 11 will comprise a manual nut 28, which will be threaded and adapted to receive and be connected to a correspondingly threaded seal bush 29, with a silicon rubber seal 30 disposed within the interior portion of the threaded seal bush 29.

Still further, according to certain embodiments, the probe 11 may comprise a hollow tube (or a series of connected hollow tubes), which are inserted into the water bottle 10. More particularly, for example, the probe 11 may comprise an upper probe 31, which includes a top portion that is connected with a port located on the bottom surface of the probe housing 25 (as described above). The invention provides that the lower portion of the upper probe 31 may further be connected to a top portion of a lower probe 33, with a seal ring 32 disposed between the upper probe 31 and lower probe 33. The seal ring 32 may be configured as, for example, a washer comprised of silicon rubber. Still further, according to certain embodiments, a top portion of a short probe 34 may be connected to the bottom portion of the lower probe 33, with a seal ring disposed therebetween. The invention provides that the upper probe 31, lower probe 33, and short probe 34 may be connected to each other through correspondingly threaded portions (i.e., such that the parts may be screwed and connected to each other), by mechanical attachment, or by frictional attachment. The multiple, interconnected hollow tubes of the probe allows the length thereof to be adjusted, in order to accommodate different water bottles and water levels, such as 3 gallons or 5 gallons.

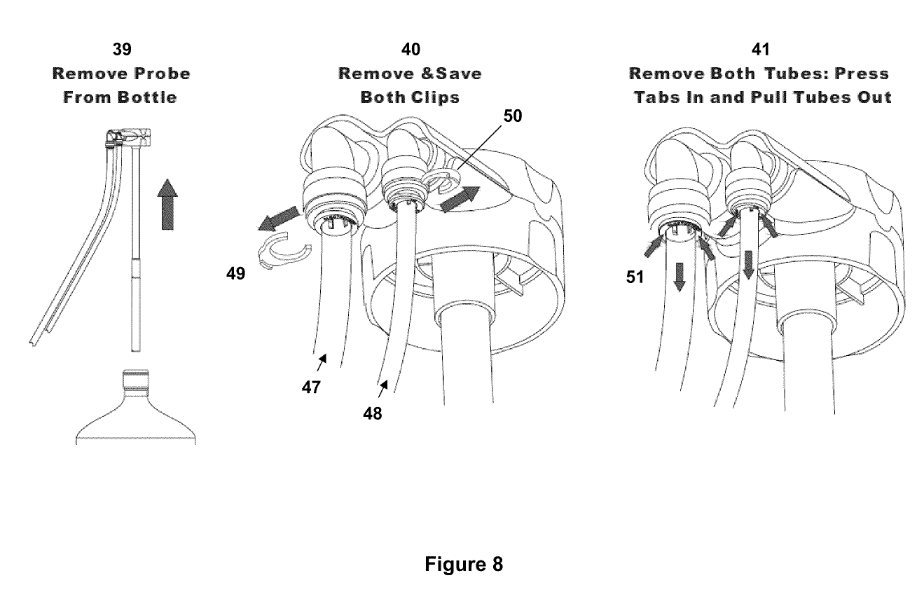

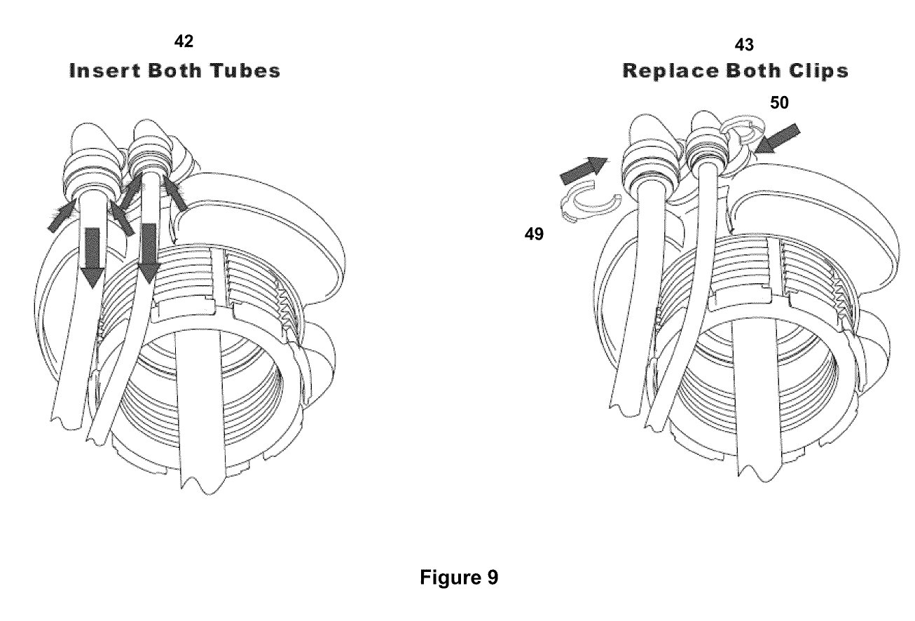

Still further, according to certain preferred embodiments, the probe 11 will further comprise two connectors 35, 36, which are configured to be attached to the two ports of the probe housing 25 described above, namely, a first port being adapted to receive a tube that will inject air into the water bottle 10 and a second port being adapted to receive a tube that will extract water from the water bottle 10 (to be eventually dispensed to a user). According to such embodiments, two separate tubes may be connected to one of either connector 35 or connector 36, whereby the connectors 35, 36 are then connected to one of either the first or second port of the probe housing 25 (which is illustrated in FIGS. 6 and 8). The connectors 35, 36 may exhibit a cylindrical-type configuration, with an approximately 90-degree bend located in a middle portion thereof, whereby a first end connects to a port of the probe housing 25 and a second end connects to a tube.

FIGS. 8-10 illustrate the steps that may be followed to disconnect the probe 11 from a water bottle 10, and to install and connect the probe 11 to a new water bottle 10. More particularly, referring to FIG. 8, the probe 11 may be lifted 39 from an empty water bottle 10. Two mechanical clips 49, 50, which secure two tubes 47,48 to the connectors 35, 36, may then be removed and disengaged 40 therefrom. Next, the tubes 47,48 may be removed (pulled out of) the connectors 35, 36. In certain embodiments, the connectors 35, 36 may include one or more tabs 51, which are disposed within the interior portion of the tubes 47,48, and exert an outward force thereon, to mechanically secure the tubes 47,48 to the connectors 35, 36. If such tabs 51 are present, the tabs may be pressed inward, such that the tubes 47,48 may be removed 41 from the connectors 35, 36, as illustrated in FIG. 8.

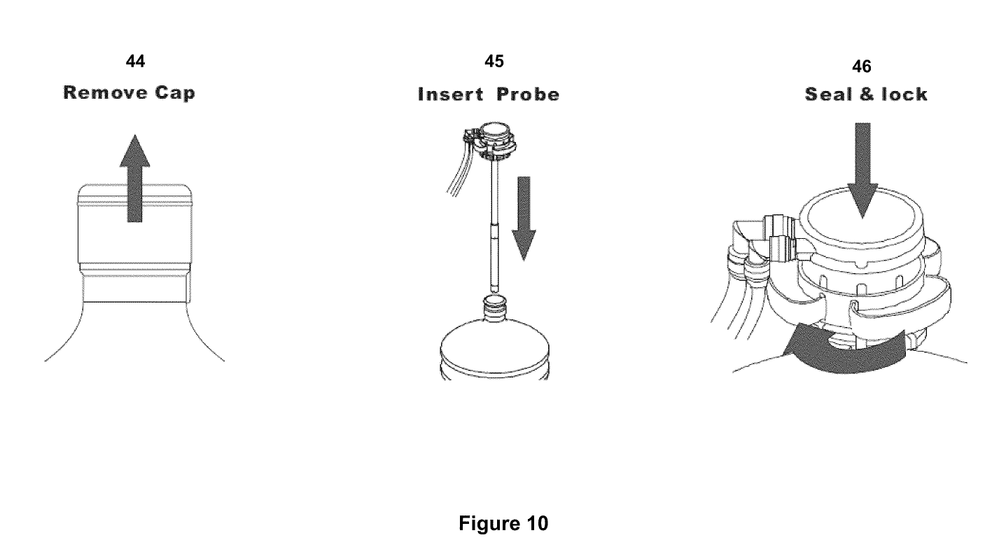

Next, the probe 11 may be cleaned and/or sterilized, prior to insertion into a new water bottle 10. Alternatively, a new probe 11 may be inserted into a new water bottle 10. Referring to FIG. 9, two separate tubes may be attached 42 to connectors 35, 36, as described herein. Preferably, mechanical clips 49, 50 may then be secured 43 to the interface between the tubes 47,48 and connectors 35, 36 (FIG. 9). Referring now to FIG. 10, the water bottle cap may be removed 44, such that the probe 11 may be inserted therein. More specifically, the interconnected upper probe 31, lower probe 33, and short probe 34 (FIG. 6) may be inserted 45 into the water bottle 10, as illustrated in FIG. 10. Finally, the probe housing 25 may be secured to the top (neck) portion of the water bottle 10, such as through correspondingly threaded portions located on the interior surface of the probe housing 25 and the top (neck) portion of the water bottle 10.

The many aspects and benefits of the invention are apparent from the detailed description, and thus, it is intended for the following claims to cover all such aspects and benefits of the invention which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A bottom loading water cooler, which comprises:
(a) a cabinet having an exterior portion and an interior portion, wherein the interior portion of the cabinet includes a top half and a bottom half;
(b) a water bottle disposed in the bottom half of the interior portion of the cabinet in an upright position;
(c) a cold tank disposed in the top half of the interior portion of the cabinet and above the water bottle;
(d) a bottle tray disposed in the bottom half of the interior portion of the cabinet that is configured to receive a bottom surface of the water bottle in the upright position, wherein the bottle tray may be reversibly pulled out of, and pushed into, the interior portion of the cabinet;
(e) a pump that injects air into the water bottle at defined and periodic intervals; and
(f) one or more tubes for transferring water from the water bottle, through the cold tank, and out of an external tap.

2. The bottom loading water cooler of claim 1, which further comprises a buoyant float, wherein, if a volume of water contained within the cold tank exceeds a threshold level, the float is buoyantly forced upwards and will cause a one-way valve that allows water to be dispensed out of, but not into, the cold tank to be closed, such that water will not exit the cold tank through the one-way valve.

3. The bottom loading water cooler of claim 2, wherein the pump (a) injects air into the water bottle for 4 seconds, (b) does not inject any air into the bottle for 10 seconds, and (c) continuously repeats steps (a) and (b).

4. The bottom loading water cooler of claim 3, which further comprises a control unit, which causes the pump to stop injecting air into the water bottle when a door attached to the cabinet, which encloses the water bottle, is in an open position.

5. The bottom loading water cooler of claim 4, wherein the cabinet is designed to rest on a floor surface, wherein the height of the cabinet ranges from 30 to 60 inches.

6. A countertop water cooler, which comprises:
(a) a cabinet having a cold tank disposed therein;
(d) a water bottle located outside of the cabinet, which is fluidly connected to the cold tank via a first tube;
(c) a pump disposed in the cabinet, which injects air into the water bottle through a second tube at defined and periodic intervals; and
(d) a third tube for transferring water from the cold tank and out of an external tap that is affixed to the cabinet.

7. The countertop water cooler of claim 6, which further comprises a buoyant float, wherein, if a volume of water contained within the cold tank exceeds a threshold level, the float is buoyantly forced upwards and will cause a one-way valve that allows water to be dispensed out of, but not into, the cold tank to be closed, such that water will not exit the cold tank through the one-way valve.

8. The countertop water cooler of claim 7, wherein the pump (a) injects air into the water bottle for 4 seconds, (b) does not inject any air into the bottle for 10 seconds, and (c) continuously repeats steps (a) and (b).

9. The countertop water cooler of claim 8, wherein the cabinet is designed to rest on a counter surface, wherein the height of the cabinet ranges from 10 to 30 inches.
